(19) United States
(12) Patent Application Publication
(10) Pub. No.: US 2026/0337107 A1
(43) Pub. Date: Oct. 29, 2026

(54) TILE ADHESIVE BASED ON GROUND GRANULATED BLAST FURNACE SLAG (GGBFS)

(71) Applicants: ECOCEM MATERIALS LIMITED, DUBLIN (IE); INSTITUT NATIONAL DES SCIENCES APPLIQUÉES DE TOULOUSE, TOULOUSE CEDEX 4 (FR); UNIVERSITE TOULOUSE III-PAUL SABATIER, TOULOUSE (FR)

(72) Inventors: Xiaoxiao GAO, TOULOUSE (FR); Roberta ALFANI, PARIS (FR); Laurent FROUIN, PARIS (FR); Martin CYR, TOULOUSE (FR)

(73) Assignees: ECOCEM MATERIALS LIMITED, DUBLIN (IE); INSTITUT NATIONAL DES SCIENCES APPLIQUÉES DE TOULOUSE, TOULOUSE CEDEX 4 (FR); UNIVERSITE TOULOUSE III-PAUL SABATIER, TOULOUSE (FR)

(21) Appl. No.: 19/099,143

(22) PCT Filed: Jul. 25, 2023
(86) PCT No.: PCT/EP2023/070528

§ 371 Date: Jan. 28, 2025

(30) Foreign Application Priority Data
Jul. 28, 2022 (EP) 22306129.2

(51) Int. Cl. C04B 28/08; C04B 7/00; C04B 7/02; C04B 7/32; C04B 11/30; C04B 16/02; C04B 103/44

(52) U.S. Cl. CPC C04B 28/08; C04B 7/006; C04B 7/02; C04B 7/323; C04B 11/30; C04B 16/02; C04B 2103/44

(57) ABSTRACT

A tile adhesive composition including at least one aggregate and a hydraulic binder formulation. The hydraulic binder formulation includes Ground Granulated Blast Furnace Slag (GGBS), more than 5 wt % and at most 30 wt % of calcium sulfate, 5 wt % or less of Ordinary Portland Cement (OPC), 10 wt % or less of ye'elimite containing cements, ye'elimite containing clinker, calcium aluminate cement (CAC), or mixtures thereof, at least one complexing and thickening polymer, selected from Cellulose Methyl Carboxylate (CMC), Gum Arabic (GA), Guar, Guar ether, Agar, Carrageenan, Xanthan Gum, Chitosan, Pectin, Hyaluronic Acid, Locust Bean Gum, and superabsorbent polymer (SAP), and at least one rheological modifier like cellulose ether different from the complexing and thickening polymer.

This disclosure pertains to the field of hydraulic binder compositions comprising Ground Granulated Blast Furnace Slag (GGBS or slag) for preparing industrial mortars. In particular, the technical field of the invention relates to hydraulic mineral binders including Ground Granulated Blast Furnace Slag, which are used in compositions able to set and harden, such as mortar compositions.

The invention also concerns the methods of preparation of these hydraulic binder compositions and of these mortars compositions able to set and harden.

### BACKGROUND ART

Portland cement production has a strong and negative impact on the environment due to the emissions of large quantities of carbon dioxide. The production of cement inherently generates CO₂ during the calcination of the raw materials at very high temperature (1450 °C) in a kiln through decarbonation of the limestone (Eq. (1)):

CaCO₃(s)→CaO(s)+CO₂(g) (Eq. (1))

In addition, carbon dioxide is released as a result of the combustion of the fossil fuels needed to heat the cement kiln. By adding the additional emissions of grinding, almost one ton of CO₂ per ton of Portland cement is obtained. Overall, the cement industry is responsible for about 7 to 9% of the global carbon dioxide emissions.

Moreover, handling Portland cement may lead to health issues (such as allergy) due, in particular, to its high alkalinity (pH higher than 13). In addition, hazardous elements as hexavalent Chromium (Cr (VI)) may be released upon kneading, which is also unhealthy for the workers when it gets in contact with the skin. Although Cr (VI) reducing agents (as ferrous sulfate) are normally included in the cement powder, their efficiency is limited in time. Building workers, in particular those in the third world, are not expected to often check the deadline related to such treatments.

Most current research on new binders aims to replace cement in various applications by binders with lower environmental impact. One route is through using resources without their expensive treatment, such as by-products from other industries (waste for one industry, but primary resource for others). This is the case of blast-furnace slag which is a by-product of iron industry. By grinding this product into fine powder (GGBS) one can obtain a cementitious material that can be used in partial substitution of cement or used alone by adding some chemical activators.

It is important to note that the use of a GGBS is not only environmentally-friendly but also leads to several enhanced properties when it's used to formulate mortars, such as high resistance to sulfate attack, low permeability, good resistance in a chemically aggressive environment, low heat of hydration (required in massive structures), excellent durability in general, possibility of immobilization of heavy metals or radionuclides, etc.

However, contrary to Portland cement the GGBS based cement needs an alkaline activator for forming hardened mortars. Unfortunately, these alkaline activators are irritating for the user. Some effort has been made for limiting the amount of alkaline activator needed. For instance, patent U.S. Pat. No. 8,932,402 B2 discloses a hydraulic binder composition wherein the alkaline activator (the base) is in an amount of 1 wt % or less. Despite the benefice of this decrease amount of alkaline activator, the mechanical properties of the resulting mortar could be improved.

Generally, calcium sulfate is used to accelerate the hardening of GGBS-based cements. However, super sulfated cements having a high content of GGBS and more than 5 wt % of calcium sulfates undergo a rapid carbonation in presence of carbon dioxide even at atmospheric concentration what leads to a flexural strength decrease.

Organic polymers, like cellulose ethers, latex, retardant agents, water-reducing agents and anti-shrinkage agents, are generally used for modifying the rheology state of mortars and improving the mechanical and durability performance in long term.

Some organic polymers, like cellulose ethers and latex are essential components of some industrial mortars, like tile adhesives, repairs, etc. Unfortunately, in GGBS rich-based binder composition with alkali activations/rich-cations activation system most of polymers, like cellulose ethers and latex, are not resistant to alkaline/cation environment and their action is strongly affected.

In this context, the invention aims at addressing at least one of the above problems and/or needs, through fulfilling at least one of the following objectives:
O1—Providing a GGBS-based binder or a mortar composition including said GGBS-based binder, which is attractive substitute to Ordinary Portland Cement (OPC)-based compositions.
O2—Providing a slag-based binder or a mortar composition including said GGBS-based binder, which is environmentally friendly.
O3—Providing a slag-based binder or a mortar composition including said GGBS-based binder, which is more acceptable than OPC-based compositions, with respect to the health and safety issues.
O4—Providing a slag based binder or a mortar composition including said GGBS-based binder, which gives rise to dry-mortars, wet mortars formulations with appropriate ability to be manufactured by several ways, like vibro-compaction, spraying, trowelling, casting, etc.
O5—Providing a slag-based binder or a mortar composition including said GGBS-based binder, which gives rise to wet formulations with appropriate rheological properties, i.e stable rheology (good workability) during the usual setting time (e.g. from some minutes to several hours) required by the users of said wet formulation.
O6—Providing a slag-based binder or a mortar composition including said GGBS-based binder, which gives rise to a hardened material with required mechanical properties, especially an acceptable early strength (for instance 24 hours).
O7—Providing a slag-based binder or a mortar composition including said GGBS-based binder, which gives rise to a hardened material with required durability.
O8—Providing a slag-based binder or a mortar composition including said GGBS-based binder, which gives rise to a hardened material with the usually required setting time (e.g. from some minutes to several hours).
O9—Providing a simple and cheap method of preparation of the GGBS-based binder or the mortar composition including said GGBS-based binder, which complies with at least one of the objectives -O1- to -O8-.
O10—Providing a simple and cheap method of preparation of a wet form of the slag-based binder or a mortar composition including said GGBS-based binder.
O11—Providing hardened products for the building industry including GGBS as the main component of the hydraulic binder.
O12—Proposing strength's enhancer admixtures to improve the hydration of a sulfated cement.

### SUMMARY

The above objectives are reached thanks to a tile adhesive composition comprising at least one aggregate and a hydraulic binder formulation, said hydraulic binder formulation comprising:
Ground Granulated Blast Furnace Slag (GGBS),
More than 5 wt % and, preferably at most 30 wt % of calcium sulfate,
5 wt % or less of Ordinary Portland Cement (OPC),
10 wt % or less of ye'elimite containing cements, ye'elimite containing clinker, calcium aluminate cement (CAC), calcium aluminate clinker or mixtures thereof,
at least one complexing and thickening polymer, selected from the group consisting of Cellulose Methyl Carboxylate (CMC), Gum Arabic (GA), Guar, Guar ether, Agar, Carrageenan, Xanthan Gum, Chitosan, Pectin, Hyaluronic Acid, Locust Bean Gum, superabsorbent polymer (SAP), and
at least one rheological modifier like cellulose ether different from the complexing and thickening polymer.

The invention also concerns dry mortar compositions comprising the above-mentioned tile adhesive composition.

The invention is also directed to wet mortar compositions, comprising the above-mentioned tile adhesive composition.

The invention further concerns hardened mortar obtained from the wet mortar composition mentioned above.

The invention is in addition directed to a process for preparing the wet mortar composition mentioned above, comprising a step of mixing with water, the tile adhesive composition mentioned above, the tile adhesive composition being prepared before the mixing step or in situ during the mixing step from at least some of the different components of the tile adhesive composition taken separately and/or under the form of premix(es).

The invention also concerns a method for improving the hydration of a sulfated cement, said sulfated cement comprising:
Ground Granulated Blast Furnace Slag (GGBS),
More than 5 wt % and, preferably at most 30 wt % of calcium sulfate,
5 wt % or less of Ordinary Portland Cement (OPC),
10 wt % or less of ye'elimite containing cements, ye'elimite containing clinker, calcium aluminate cement (CAC), calcium aluminate clinker or mixtures thereof,
   said method comprising the following step:
   S1: providing the following components:
Ground Granulated Blast Furnace Slag (GGBS),
the calcium sulfate,
the Ordinary Portland Cement (OPC),
the ye'elimite containing cements, ye'elimite containing clinker, calcium aluminate cement (CAC), calcium aluminate clinker or mixtures thereof,
   S2: providing at least one strength's enhancer admixture being a complexing and thickening polymer, selected from the group consisting of Cellulose Methyl Carboxylate (CMC), Gum Arabic (GA), Guar, Guar ether, Agar, Carrageenan, Xanthan Gum, Chitosan, Pectin, Hyaluronic Acid, Locust Bean Gum, superabsorbent polymer (SAP), preferably from the group consisting of CMC and GA, and
   S3: providing at least one rheological modifier like cellulose ether different from the complexing and thickening polymer
   S4: mixing said component with water.

### DEFINITIONS

According to the terminology of this text, the following non limitative definitions have to be taken into consideration:

“slag” denotes a stony by-product matter separated from metals during the smelting or refining of ore.

“GGBS” or “GGBFS”: Ground Granulated Blast Furnace Slag, which is equivalent to blast furnace slag, Granulated Blast Furnace Slag (GBFS), blast furnace water-crushed slag powder and blast furnace slag fine aggregate.

“clinker” and “cement” are understood as meaning a powdery substance made for use in making mortar. They are mineral binders, possibly free from any organic compound.

“binder” refers to “hydraulic binder” meaning any material that hardens just by adding water, like GGBS and cement.

“mortar” refers to a material composed of binder(s), aggregates such as sand and other components, like admixtures.

“d₅₀” gives the median size of the granulometric distribution of material's particles (usually in micrometers for cementation materials). It means that 50 wt % of the particles have a size less than the specified number and 50 wt % of the particles have a size greater than the given number. The measurement of d₅₀ is done by Laser diffraction analysis, also known as Laser diffraction spectroscopy, by means of Laser diffraction analyzer such as “Mastersizer 2000” and commercialized by the MALVERN company, with the humid way method.

“water retention agent” is a compound having the property of keeping the water of mixing before the setting. The water is so trapped in the wet formulation paste which improves its bond. To some extent, the water is less absorbed by the support.

“thickening agent” means compounds able to increase the viscosity of a composition.

“X or less” without any lower limit indicated means that both “X” and “0” are included in the range.

“between A and B” means that both A and B are included in the range.

### DETAILED DESCRIPTION

As mentioned above, the invention is directed to a tile adhesive composition comprising at least one aggregate and a hydraulic binder formulation, said hydraulic binder formulation comprising:
the ground Granulated Blast Furnace Slag (GGBS),
More than 5 wt % and, preferably at most 30 wt % of calcium sulfate,
5 wt % or less of Ordinary Portland Cement (OPC),
10 wt % or less of ye'elimite containing cements, ye'elimite containing clinker, calcium aluminate cement (CAC), calcium aluminate clinker or mixtures thereof,
at least one complexing and thickening polymer, selected from the group consisting of Cellulose Methyl Carboxylate (CMC), Gum Arabic (GA), Guar, Guar ether, Agar, Carrageenan, Xanthan Gum, Chitosan, Pectin, Hyaluronic Acid, Locust Bean Gum, superabsorbent polymer (SAP), and
at least one rheological modifier like cellulose ether different from the complexing and thickening polymer.

### The Ground Granulated Blast Furnace Slag (GGBS)

In some embodiments, the quantity of GGBS is between 55 wt % and 95 wt %, advantageously between 65 wt % and 95 wt %, and more advantageously between 75 wt % and 95 wt %.

In an advantageous embodiment at least a part of the GGBS is superfine GGBS. Superfine GGBS is GGBS particles of which has a d₅₀ between 6000~8500 g/cm², advantageously between 6500 and 8250 g/cm², and more advantageously between 7000 and 8000 g/cm². In this advantageous embodiment, the hydraulic binder composition according to the invention comprises GGBS, wherein between 1 wt % and 50 wt % of the GGBS is superfine GGBS, advantageously between 5 wt % and 35 wt %, and more advantageously between 12 wt % and 24 wt %.

This proportion of superfine GGBS lead to the improvement of resistance in water immersion of the resulting hardened mortar compared to the mortars according to the invention not including superfine GGBS.

### The Calcium Sulfate

The hydraulic binder composition according to the invention comprises more than 5 wt % and preferably at most 30 wt % of calcium sulfate.

The calcium sulfate may be anhydrite calcium sulfate, hemi-hydrate calcium sulfate, dihydrate calcium sulfate, or mixture thereof. Advantageously, the quantity of calcium sulfate is between 5 wt % and 30 wt %, advantageously between 5 wt % and 25 wt %, and more advantageously between 5 wt % and 20 wt %.

### The Ordinary Portland Cement (OPC)

According to the invention, the hydraulic binder may comprise 5 wt % or less of OPC, advantageously between 0 wt % and 2.5 wt % or less and more advantageously between 0 wt % of 0.5 wt % or less.

In the present disclosure, OPC is meant as any OPC according to standard EN 197-1.

### The Ye'Elimite Containing Cements, Ye'Elimite Containing Clinker, Calcium Aluminate Cement (CAC) and Calcium Aluminate Clinker

Advantageously, in the hydraulic binder composition the total quantity of ye'elimite containing cements, ye'elimite containing clinker and CAC is between 0 wt % and 10 wt %, advantageously between 0.5 wt % and 5 wt %, and more advantageously between 2.5 wt % and 5 wt %.

The presence of ye'elimite containing cements, ye'elimite containing clinker, and/or CAC allows increasing the early strength at 24 h of the resulting hardened mortar.

The ye'elimite containing cements may be a sulfoaluminate cement (CSA).

In an advantageous embodiment, the hydraulic binder composition comprises between 10 wt % and 80 wt % of CSA, advantageously between 30 wt % and 70 wt % of CSA, and more advantageously between 40 wt % and 60 wt % of CSA.

The CAC may be chosen in the group comprising monocalcium aluminate (CA) and/or mayenite (C₁₂A₇).

### The Complexing and Thickening Polymer

According to the invention, the hydraulic binder composition comprises at least one complexing and thickening polymer selected from the group consisting of Cellulose Methyl Carboxylate (CMC), Gum Arabic (GA), Guar, Agar, Carrageenan, Xanthan Gum, Chitosan, Pectin, Hyaluronic Acid, Locust Bean Gum. In a preferred embodiment, the complexing and thickening polymer is selected from the group comprising CMC and GA.

Advantageously, the quantity of organic complexing and thickening agent is between 0 wt % and 1.0 wt %, advantageously between 0.1 wt % and 0.5 wt %, and more advantageously between 0.2 wt % and 0.4 wt %.

### The Rheological Modifier

The hydraulic binder composition according to the invention comprises at least one rheological modifier.

The rheological modifier may be selected from methylcellulose (MC), methylhydroxyethylcellulose (MHEC), Methylhydroxypropylcellulose (MHPC), Hydroxyethylcellulose (HEC) and Hydroxypropylcellulose (HPC), Ethyl hydroxyethyl cellulose (EHEC).

In an advantageous embodiment, the quantity of rheological modifier is between 0 wt % and 1.0 wt %, advantageously between 0.1 wt % and 0.5 wt %, and more advantageously between 0.2 wt % and 0.4 wt %.

### The Aggregates

Aggregates comprise a large category of particulate material used in construction, including sands, gravels, crushed stones, slag (not-granulated), recycled concrete and geosynthetic aggregates. They serve as reinforcement to add strength to the overall composite material.

### The Dry Mortar Composition

The invention also relates to dry mortar compositions comprising the tile adhesive, composition described above. The dry mortar composition may eventually contain other admixtures and additions.

According to the invention, “dry” mortar compositions refer to compositions that are in the form of powder and ready to be mixed with water. In other words, the dry mortar composition of the invention may content some moisture, but it essentially contains solid components which are intended to be mixed with water before its application.

Advantageously, said dry mortar composition can also include, apart from aggregates, one or several ingredients, especially functional admixtures, additions and fibres. In particular, these ingredients are chosen among additives selected from the group comprising filler, supplementary cementitious material, water reducing polymers, latex, water retention agent, rheological agent, defoamer/antifoams, biocide, pigment, flame retardant, air-entraining agents and retarders like the following compounds:

### Defoamer/Antifoams

The possible defoamer is preferably chosen in the group comprising, more preferably consisting in: polyether polyols and mixes thereof.

### Biocide

The possible biocide is preferably chosen in the group comprising, more preferably consisting in: mineral oxides like zinc oxide and mixes thereof.

### Pigment

The possible pigment is preferably chosen in the group comprising, more preferably consisting in: TiO₂, iron oxide and mixes thereof.

### Flame Retardant

Flame retardant (or flame proof agent) makes it possible to increase the fire resistance and/or to shrink the speed of flame spreading of the composition.

### Air-Entraining Agents

Air-entraining agents (surfactants) are advantageously chosen in the group comprising, more preferably consisting in, natural resins, sulfated or sulfonated compounds, synthetic detergents, organic fatty acids and their mixes, preferably in the group comprising, more preferably consisting in the lignosulfonates, the basic soaps of fatty acids and their mixes, and, more preferably in the group comprising, more preferably consisting in the sulfonate olefins, the sodium lauryl sulfate and their mixes.

### Retarders

Retarders are advantageously chosen in the group comprising, more preferably consisting in tartric acid and its salts: sodium or potassium salts, citric acid and its salts: sodium (trisodic citrate) and their mixes.

In addition, other components may be:
Plasticizers
Fibres
Dispersion powders
Wetting agents
Polymeric resins
Complexing agents
Drying shrinkage reducing agents based on polyols.

The total content of these optional other components in the dry mortar composition is preferably comprised between 0 wt % and 5 wt % by weight of the total weight of the binder composition, advantageously between 0.2 wt % and 2 wt %, and more advantageously between 0.5 wt % and 1 wt %.

### The Wet Mortar Composition

The invention also refers to a wet mortar composition comprising the tile adhesive composition described above and water.

In a specific embodiment, in the wet mortar composition according to the invention the mass ratio water/hydraulic binder composition is between 0.30 and 0.63, advantageously between 0.34 and 0.48, and more advantageously between 0.38 and 0.42.

### The Process for Preparing Wet Mortar Composition

The invention also relates to a process for preparing the wet mortar composition described above comprising a step of mixing with water at least the tile adhesive composition described above, the tile adhesive composition being prepared before the mixing step or in situ during the mixing step from at least some of the different components of the binder composition taken separately and/or under the form of premix(es).

In other words, wet mortar composition could be prepared by two distinct methods.

In a first method, the tile adhesive composition is prepared. The dry mortar composition is thereafter mixed with water.

In a second method, the wet mortar composition is prepared by mixing in water each component of the tile adhesive composition.

According to the present disclosure, the term “mixing” has to be understood as any form of mixing.

In a preferred embodiment a part of the binder composition and at least a part of the water are mixed together prior to the mixing with the aggregate.

### Hardened Industrial Mortar Composition

The present invention also refers to hardened mortar composition obtained from the wet mortar composition described above.

### The Method for Improving the Hydration of a Sulfated Cement

As mentioned above, the invention also concerns a method for improving the hydration of a sulfated cement, said sulfated cement comprising:
Ground Granulated Blast Furnace Slag (GGBS),
More than 5 wt % and, preferably at most 30 wt % of calcium sulfate,
5 wt % or less of Ordinary Portland Cement (OPC),
10 wt % or less of ye'elimite containing cements, ye'elimite containing clinker, calcium aluminate cement (CAC), calcium aluminate clinker or mixtures thereof,
   said method comprising the following step:
   S1: providing the following components:
the ground Granulated Blast Furnace Slag (GGBS),
the calcium sulfate,
the Ordinary Portland Cement (OPC),
the ye'elimite containing cements, ye'elimite containing clinker, calcium aluminate cement (CAC), calcium aluminate clinker or mixtures thereof,
   S2: providing at least one strength's enhancer admixture being a complexing and thickening polymer, selected from the group consisting of Cellulose Methyl Carboxylate (CMC), Gum Arabic (GA), Guar, Guar ether, Agar, Carrageenan, Xanthan Gum, Chitosan, Pectin, Hyaluronic Acid, Locust Bean Gum, superabsorbent polymer (SAP), preferably from the group consisting of CMC and GA, and
   S3: providing at least one rheological modifier like cellulose ether different from the complexing and thickening polymer
   S4: mixing said component with water.

The components provided at steps S1, S2 and S3 may be blended before the mixing step S4 or in situ during the mixing step said components being taken separately and/or under the form of premix(es).

In other words, method may be implemented by two distinct processes.

In a first process, the components provided at steps S1, S2 and S3 are blended together and thereafter mixed with water at step S4.

In a second process, the components provided at steps S1, S2 and S3 are introduced one by one, or introduces in the form of premixes of some of said components, in water and then the mixing step S4 is carried out.

### EXAMPLES

### Example 1: Tile Adhesive Compositions Comprising the Hydraulic Binder According to the Invention

A hydraulic binder composition is prepared by mixing GGBS, calcium sulfate, OPC, a CSA having a blaine of 5000±250 cm²/g and containing more than 55% of ye'elimite and less than 10% of belite, UP1560 which is a cellulose ether sold by Ashland®, and CMC the proportion are given in table 1 below, which takes totally 47.48% of dry mix.

TABLE 1

| Type of component | Component | Wt % |
|---|---|---|
| GGBS | GGBS and | 86.4 |
| | superfine | |
| | GGBS | |
| Calcium sulfate | Anhydrite | 8.2 |
| OPC | OPC | 0.4 |
| containing cements, ye'elimite | CSA | 4.2 |
| containing clinker, and/or CAC | | |
| Complexing and thickening | CMC | 0.4 |
| polymer | | |
| Rheological modifier | UP1560 | 0.4 |
| Water | | 40 |

This hydraulic binder composition is mixed with 2.5 wt % of Vinnapas 7220, which is a latex sold by Wacker®, and 50.02 wt % of sand to obtain a dry tile adhesive composition according to the invention.

This dry tile adhesive composition is thereafter mixed with 19 wt % of water compared to the total weight of the dry tile adhesive composition to obtain a wet tile adhesive composition according to the invention.

The initial consistency of the wet tile adhesive composition according to the invention is 431 Pa*s. The adhesive strength of the hardened tile adhesive conforms to the standard EN12004 as C2TE type, as shown in Table 2 below which set forth the measurements of 3 samples of hardened tile adhesive composition are conducted at 24 h, 7 days, 14 days and 28 days to study the strength evolution with a storage of (20±2) °C and (50±5) % relative humidity.

TABLE 2
Adhesive strength (unit on MPa equal to N/mm²)

| | 24 h | 7 d | 14 d | 28 d | T^{20 min} | T^{30 min} | WATER | HEAT |
|---|---|---|---|---|---|---|---|---|
| Sample 1 | 0.21 | 1.08 | 1.36 | 1.20 | 1.21 | 1.20 | 1.25 | 1.26 |
| Sample 2 | 0.26 | 0.96 | 1.37 | 1.40 | 0.89 | 0.73 | 1.33 | 1.30 |
| Sample 3 | 0.25 | 1.02 | 1.31 | 1.50 | 0.91 | 0.79 | 1.26 | 1.45 |
| Average | 0.24 | 1.02 | 1.35 | 1.37 | 1.00 | 0.91 | 1.28 | 1.34 |

Open time T^{20min} and T^{30min} is defined as the “maximum interval after tile adhesive application, at which tiles can be embedded in the applied adhesive and meet the specified tensile adhesion strength requirement”. To evaluate open time, after the preparation of test units, five tiles are placed after respectively 20 and 30 minutes since Tomin on the fresh adhesive and loaded with masses of 20N for 30 s.

After 7 days of drying under dry conditions of (20±2) °C and (50±5) % relative humidity, test units are immersed in water at the standard temperature. After 20 days, tests units are removed from water and wiped with a cloth to bond the pull-head plates to the tiles. After a further 24 h, necessary to the drying of the adhesive, the tests units are immersed in water. At 28 days, the tests units are removed from water and immediately pulled off with the tensile testing machine for WATER measurement.

After 14 days of drying under conditions of (20±2) °C and (55±5) % relative humidity, test units are placed in an air-circulating oven at (70±3) °C for a further 14 days. Then, they are removed from the oven to bond the pull-head plates to the tiles and placed under standard conditions during still 24 h, necessary to the drying of the adhesive. At 28 days, test units are pulled off with the tensile testing machine for HEAT measurement.

### Example 2

A hydraulic binder composition is prepared by mixing GGBS, calcium sulfate, OPC, a CSA having a blaine of 5000±250 cm²/g and containing more than 55% of ye'elimite and less than 10% of belite, UP1560 which is a cellulose ether sold by Ashland®, and GA the proportion are given in table 3 below:

TABLE 3

| Type of component | Component | Wt % |
|---|---|---|
| GGBS | GGBS and | 86.4 |
| | superfine | |
| | GGBS | |
| Calcium sulfate | Anhydrite | 8.2 |
| OPC | OPC | 0.4 |
| containing cements, ye'elimite | CSA | 4.2 |
| containing clinker, and/or CAC | | |
| Complexing and thickening | GA | 0.4 |
| polymer | | |
| Rheological modifier | UP1560 | 0.4 |
| Water | | 40 |

This hydraulic binder composition is mixed with 2.5 wt % of Vinnapas 7220, which is a latex sold by Wacker®, and 50.02 wt % of sand to obtain a dry tile adhesive composition according to the invention.

This dry tile adhesive composition is thereafter mixed with 19 wt % of water compared to the total weight of the dry tile adhesive composition to obtain a wet tile adhesive composition according to the invention.

The initial consistency of the wet tile adhesive composition according to the invention is 367 Pa*s. The adhesive strength of the hardened tile adhesive conforms to the standard EN12004 as C2TE type, as shown in Table 4 below which set forth the measurements of 3 samples of hardened tile adhesive composition are conducted at 24 h, 7 days, 14 days and 28 days to study the strength evolution with a storage of (20±2) °C and (50±5) % relative humidity.

TABLE 4
Adhesive strength (unit on MPa equal to N/mm²)

| | 24 h | 7 d | 14 d | 28 d | T^{20 min} | T^{30 min} | WATER | HEAT |
|---|---|---|---|---|---|---|---|---|
| SSC2 | 0.24 | 0.73 | 1.08 | 1.07 | 0.87 | 0.83 | 1.18 | 1.21 |
| (LMDC) | | | | | | | | |

1-16. (canceled)

17. A tile adhesive composition comprising at least one aggregate and a hydraulic binder formulation, said hydraulic binder formulation comprising:
Ground Granulated Blast Furnace Slag (GGBS),
more than 5 wt % and at most 30 wt % of calcium sulfate,
5 wt % or less of Ordinary Portland Cement (OPC),
10 wt % or less of ye'elimite containing cements, ye'elimite containing clinker, calcium aluminate cement (CAC), calcium aluminate clinker or mixtures thereof,
at least one complexing and thickening polymer, selected from the group consisting of Cellulose Methyl Carboxylate (CMC), Gum Arabic (GA), Guar, Guar ether, Agar, Carrageenan, Xanthan Gum, Chitosan, Pectin, Hyaluronic Acid, Locust Bean Gum, and superabsorbent polymer (SAP), and
at least one rheological modifier different from the complexing and thickening polymer.

18. The tile adhesive composition according to claim 17, wherein the complexing and thickening polymer is selected from the group consisting of CMC and GA.

19. The tile adhesive composition according to claim 17, wherein the GGBS is between 55 wt % and 95 wt % of the tile adhesive composition.

20. The tile adhesive composition according to claim 17, wherein the calcium sulfate is between more than 5 wt % and 30 wt % of the tile adhesive composition.

21. The tile adhesive composition according to claim 17, wherein the OPC is less than 3 wt % of the tile adhesive composition.

22. The tile adhesive composition according to claim 21, wherein a total quantity of ye'elimite containing cements, ye'elimite containing clinker and/or CAC is between 0 wt % and 10 wt % of the tile adhesive composition.

23. The tile adhesive composition according to claim 17, wherein the complexing and thickening agent is between 0 wt % and 1.0 wt % of the tile adhesive composition.

24. The tile adhesive composition according to claim 17, wherein the rheological modifier is between 0 wt % and 1.0 wt % of the tile adhesive composition.

25. The tile adhesive composition according to claim 17, wherein between 1 wt % and 50 wt % of the GGBS is superfine GGBS.

26. A dry mortar composition comprising the tile adhesive composition according to claim 17.

27. The dry mortar composition according to claim 26, further comprising at least one additive selected from the group consisting of filler, supplementary cementitious material, water reducing polymers, latex, water retention agent, rheological agent, defoamer/antifoams, biocide, pigment, flame retardant, air-entraining agents and retarders.

28. A wet mortar composition comprising the tile adhesive composition, according to claim 17 and water.

29. The wet mortar composition according to claim 28, wherein the water and the hydraulic binder formulation are in a mass ratio of water/binder composition between 0.30 and 0.63.

30. A hardened mortar obtained from the wet mortar composition according to claim 28.

31. A process for preparing the wet mortar composition according to claim 28, comprising a step of mixing with water, the tile adhesive composition comprising the at least one aggregate and the hydraulic binder formulation, the hydraulic binder formulation being prepared before the mixing step or in situ during the mixing step from at least some of different components of the hydraulic binder formulation taken separately and/or in a form of premix(es).

32. A method for improving hydration of a sulfated cement, said sulfated cement comprising:
Ground Granulated Blast Furnace Slag (GGBS),
more than 5 wt % and at most 30 wt % of calcium sulfate,
5 wt % or less of Ordinary Portland Cement (OPC),
10 wt % or less of ye'elimite containing cements, ye'elimite containing clinker, calcium aluminate cement (CAC), calcium aluminate clinker or mixtures thereof,
said method comprising the following steps:
S1: providing the following components:
the GGBS,
the calcium sulfate,
the OPC,
the ye'elimite containing cements, ye'elimite containing clinker, CAC, calcium aluminate clinker or mixtures thereof,
S2: providing at least one strength's enhancer admixture being a complexing and thickening polymer, selected from the group consisting of Cellulose Methyl Carboxylate (CMC), Gum Arabic (GA), Guar, Guar ether, Agar, Carrageenan, Xanthan Gum, Chitosan, Pectin, Hyaluronic Acid, Locust Bean Gum, and superabsorbent polymer (SAP),
S3: providing at least one rheological modifier different from the complexing and thickening polymer, and
S4: mixing said at least one strength's enhancer admixture, at least one rheological modifier, at least one strength's enhancer admixture, and least one rheological modifier different from the complexing and thickening polymer with water.
